(19) United States
(12) Patent Application Publication
(10) Pub. No.: US 2026/0117037 A1
(43) Pub. Date: Apr. 30, 2026

(54) Methods for Preparing Self-Structured Cellulose Aerogel Materials from Hydrogel and Their Applications

(71) Applicant: Board of Trustees of Western Michigan University, Kalamazoo, MI (US)

(72) Inventor: Jinghao Li, Kalamazoo, MI (US)

(21) Appl. No.: 19/373,685

(22) Filed: Oct. 29, 2025

Related U.S. Application Data
(60) Provisional application No. 63/713,546, filed on Oct. 29, 2024.

(51) Int. Cl. C08J 9/28; C08B 1/08; C08J 9/00; C08K 3/04

(52) U.S. Cl. CPC C08J 9/283; C08B 1/08; C08J 9/0061; C08J 9/0085; C08K 3/041; C08J 2205/026; C08J 2301/26

(57) ABSTRACT

Aspects of the present disclosure may include methods of preparing a cellulose-based aerogel including: preparing an alkali cellulose; reacting the alkali cellulose with an alkylating agent to form alkylated cellulose; mixing the alkylated cellulose with fibrillated cellulose comprising carboxyl groups in an aqueous solution to form a foam; and drying the foam to form a cellulose-based aerogel. Embodiments of the present disclosure may include a cellulose-based closed-foam aerogel, the closed-cell aerogel including: an alkylated cellulose; a fibrillated carboxylated cellulose; wherein the alkylated cellulose and the fibrillated carboxylated cellulose are mixed to foam, wherein the foam is capable of being dried under ambient conditions to form the closed-cell aerogel.

### CROSS REFERENCE TO RELATED APPLICATIONS

This application claims priority to U.S. Provisional Application 63/713,546 filed on Oct. 29, 2024, the contents of which are incorporated by reference in their entirety.

### FIELD OF THE INVENTION

The present disclosure relates to the field of material science, specifically to methods for preparing aerogel materials. More particularly, it focuses on the preparation of non-freeze-dried, self-structured cellulose aerogel materials derived from hydrogels. These aerogels exhibit lightweight, porous structures with excellent thermal and acoustic insulation as well as mechanical properties, making them suitable for a variety of applications, including but not limited to, packaging, insulation, food coatings, and biodegradable and compostable materials.

### BACKGROUND OF THE INVENTION

Aerogels are lightweight, porous materials that have garnered attention due to their low density and excellent thermal insulation properties. Traditionally, aerogels, particularly cellulose aerogels, require freeze-drying to remove carrier solvents such as water from their structures, making the process energy-intensive and time-consuming.

The current invention seeks to address these problems by providing a method for producing a closed-cell cellulose aerogel without the need for freeze-drying or additional foaming chemical reaction agents. Embodiments of the self-drying cellulose aerogel produced as described herein in aspects of disclosure have superior mechanical properties, impact resistance, and biodegradability. Moreover, many aspects of the methods described herein produce closed-cell aerogels, which offer superior thermal and acoustic insulation compared to open-cell aerogels produced by many freeze-drying processes of the prior art, making the aerogels described herein more suitable for applications including, but not limited to, disposable products, packaging, thermal or acoustic insulation, food coating, and biodegradable and compostable materials.

### SUMMARY OF THE INVENTION

Aspects of the present disclosure may include methods of preparing a cellulose-based aerogel including: preparing an alkali cellulose; reacting the alkali cellulose with an alkylating agent to form alkylated cellulose; mixing the alkylated cellulose with fibrillated cellulose comprising carboxyl groups in an aqueous solution to form a foam; and drying the foam to form a cellulose-based aerogel.

Other aspects may further include pouring the foam into a mold. Yet others may include shaping the foam by vibrating and/or mechanically smoothing the top of the foam. Others may further include spraying the foam on a surface and/or contacting a surface with the foam.

In yet others, the alkali cellulose is prepared using sodium hydroxide. In others, the alkylating agent is selected from one or more of methyl iodide, ethyl iodide, methyl chloride, ethyl chloride (C₂H₅Cl), dimethyl sulfate.

In others, the fibrillated cellulose is carboxylated via TEMPO-mediated oxidation. In others, the fibrillated cellulose is fibrillated using high-pressure homogenization and/or mechanical grinding.

In yet other aspects, wherein the alkylated cellulose and fibrillated cellulose are mixed in a ratio of about 0.1:1 to 1:0.1. In others, mixing the alkylated cellulose with fibrillated cellulose including carboxyl groups in an aqueous solution occurs for a time between about 1 and 100 minutes.

Other aspects further include adding additional foaming agents, crosslinkers, reinforcement agents, waterproofing agents or other adjuncts to the foam and/or aerogel. In some aspects, the aerogel is a closed-cell material.

Other aspects of the present disclosure may include a method of preparing a cellulose-based aerogel, including: rehydrating a first cellulose-based aerogel comprising alkylated cellulose and fibrillated cellulose; mechanically grinding the rehydrated aerogel; mixing the ground aerogel in an aqueous solution to form a foam; and drying the foam to form a second cellulose-based aerogel.

Embodiments of the present disclosure may include a cellulose-based closed-foam aerogel, the closed-cell aerogel including: an alkylated cellulose; a fibrillated carboxylated cellulose; wherein the alkylated cellulose and the fibrillated carboxylated cellulose are mixed to foam, wherein the foam is capable of being dried under ambient conditions to form the closed-cell aerogel.

In other embodiments, the alkylated cellulose is prepared from alkali cellulose and an alkylating agent. In others, the fibrillated carboxylated cellulose is carboxylated via TEMPO-mediated oxidation and fibrillated using high-pressure homogenization and/or mechanical grinding. In yet others, the cellulose-based closed-foam aerogel of claim 15, wherein the alkylated cellulose and fibrillated cellulose are mixed in a ratio of about 0.1:1 to 1:0.1.

Other embodiments further include foaming agents, crosslinkers, reinforcement agents, waterproofing agents and/or other adjuncts. In others, the aerogel is recyclable and/or biodegradable.

Other features and advantages of the present invention will become apparent from the following detailed description, including the drawing. It should be understood, however, that the detailed description and the specific examples, while indicating preferred embodiments, are provided for illustration only, because various changes and modifications within the spirit and scope of the invention will become apparent to those skilled in the art from the detailed description.

### DESCRIPTION OF THE DRAWINGS

The drawings described herein are for illustrative purposes only of selected embodiments and not all possible implementations and are not intended to limit the scope of the present disclosure.

FIG. 1 shows a mixture of alkylated cellulose mixed with fibrous cellulose, in this case cellulose nanofibrils (USDA Forest Products Lab) in water in an example aspect of the present disclosure;

FIG. 2 shows an example mixture forming an aerogel after mechanical mixing, retaining its shape, even after being tilted 90 (inset below left) or 180 degrees (inset below right) in an example aspect of the present disclosure;

FIG. 3 shows a sample mold and molding process of the present disclosure: the example foam shown in FIG. 2 and rectangular mold (above) shown prior to pouring; the poured foam is then vibrated and levelled with a metal rod (below);

FIG. 4 shows (left) light microscopy and SEM (right) of the highly-aerated foam structure, with the white bars showing 500 μm for reference, after drying;

FIG. 5 shows an example FTIR spectrum of an example cellulose-only aerogel embodiment of the present disclosure, showing the characteristic transmittance of cellulose with few if any impurities.

### DETAILED DESCRIPTION OF THE INVENTION

Definitions. The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an,” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

The present invention provides a method for preparing non-freeze-dried, self-structured cellulose aerogel materials from hydrogels. This method eliminates the need for energy-intensive freeze-drying by leveraging a natural drying process that forms stable, closed-cell structures. The process involves modifying cellulose through alkylation, blending it with fibrillated nanocellulose to create a foamed gel mixture, and allowing the solvent to evaporate without collapsing the closed-cell gas film structure formed by a composite mixture of hierarchical cellulose fibers, resulting in a lightweight, closed-cell aerogel.

For the natural drying mechanism of this 100% cellulose aerogel, it is crucial to modify cellulose through an alkylation reaction that adds alkyl, usually short-chain alkyl groups, such as —CH₂CH₃ or —CH₃, methoxy, ethoxy, functional groups, for example, which are then mixed with cellulose nanofibrils containing carboxyl (—COOH) groups. Not to be limited by theory, it is thought that the hydrophobic and hydrophilic nature of these groups, respectively, as well as the solubility differences between the alkyl groups and carboxyl groups, create an equilibrium field that reduces water surface tension. This interaction, combined with the hierarchical structure of the cellulose fibers, forms a spherical film that stabilizes the structure while holding the water.

The cellulose bubble-containing film comprises a water layer sandwiched between two layers of cellulose molecules. It is thought that this structure not only enhances the elasticity of the bubbles but also provides a pathway for water evaporation through the highly hydrophilic cellulose nanofibrils with carboxyl groups. Thus, the cellulose mixture layers exhibit both hydrophobic and hydrophilic properties, which maintain bubble integrity while simultaneously facilitating water evaporation during drying.

Embodiments of the resulting cellulose aerogels demonstrate excellent thermal insulation properties, low density, and high mechanical resilience. In some embodiments, These materials can also be treated to enhance water resistance, expanding their applicability. Potential applications include, but are not limited to, thermal or acoustic insulation, coatings, biodegradable and compostable packaging materials, and food preservation solutions.

Moreover, the biodegradable and eco-friendly nature of the cellulose aerogels offers a sustainable alternative to conventional polymer-based insulation and packaging products, contributing to environmental sustainability and reducing reliance on non-renewable resources. The invention promises significant versatility and commercial potential in various industries, including construction, packaging, and food preservation.

### Preparation of Alkylated Cellulose

Cellulose fibers from sources like paper, cotton or biorefinery may be treated with a metal hydroxide or a mixture of metal hydroxides, such as sodium hydroxide, potassium hydroxide, and/or calcium hydroxide, for example, to form alkali cellulose. In some aspects, sodium hydroxide is used due to its effectiveness and availability.

Alkali cellulose is then reacted with alkylating agents or a mixture thereof, such as methyl iodide, ethyl iodide, methyl chloride, ethyl chloride (C₂H₅Cl), dimethyl sulfate, and others known to persons of skill in the art, at temperatures between 0° C. and 150° C. for 30 minutes to 10 hours, depending on the type of cellulose, the desired degree of substitution, and the molecular weight.

After the reaction is completed, the alkylated cellulose is neutralized using dilute acid, washed, and dried for further use. The resulting cellulose should have a viscosity between 1 cP to 5000 cP.

### Preparation of Cellulose Nanofibrils

In some aspects, preparation of fibrillated cellulose involves TEMPO-mediated oxidation to disrupt hydrogen bonds, converting it into cellulose carboxylates. Other suitable oxidation methods are possible (see e.g., methods reviewed in Lam and Hemraz Nanomaterials (Basel) 2021 22: 11(7): 1641).

Next, the oxidized cellulose is fibrillated using high-pressure homogenization, resulting in a 0.1%-2% suspension of fibrous cellulose with nanofibers of 1-1000 nm in diameter. Alternatively, other methods known in the art such as mechanical grinding can be used to achieve fibrillation.

### Blending and Foaming Process

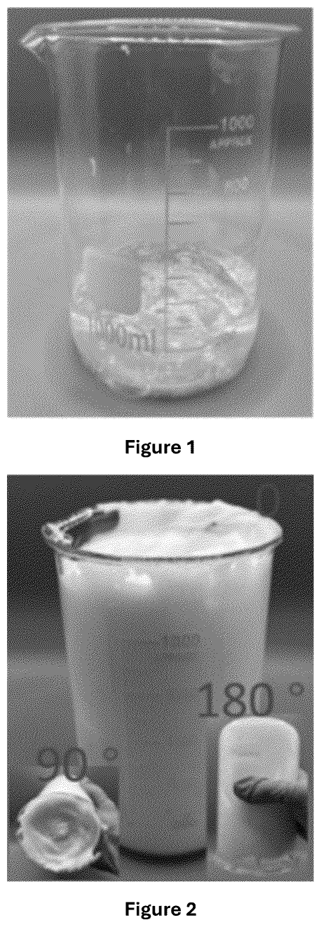

Next, the alkylated cellulose and fibrous cellulose are mixed in ratio of 0.1:1 to 1:0.1, depending on application, in preferably a water-based solution. In most cases, water can be used, but easily evaporable polar solvent mixtures (such as 5% EtOH/water, etc.) may be used. FIG. 1 shows an example mixture of alkylated cellulose mixed with fibrous cellulose, in this case cellulose nanofibrils (USDA Forest Products Lab) in water.

Optionally, an additional foaming agent (e.g., such as a CO2 generator like sodium bicarbonate or yeast) can be added to facilitate bubble formation. Optionally, one or more additional crosslinkers (e.g., starch, protein, citric acid, glutaraldehyde, isocyanates, succinic anhydride, etc.) may be added to improve structural strength and other properties. Optionally, reinforcement agents (e.g. elastic particle, metal particle, nature fibers, chitosan, etc.) could be added to enhance the strength and/or other functionality.

Other adjuncts like colorants, preservatives, scenting agents and the like may be added at this step, after wet foam formation or to the dry foam as discussed more fully below.

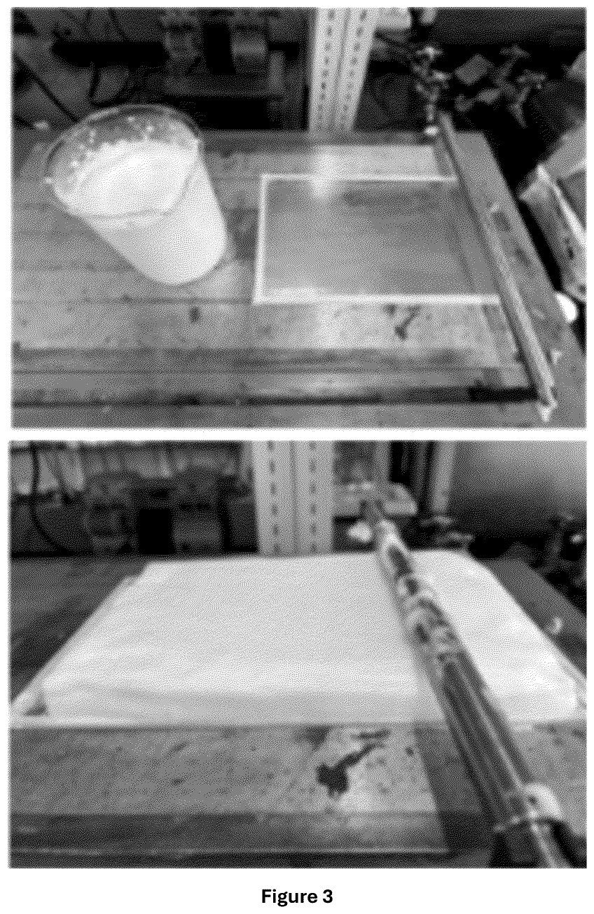

To generate the foam, the mixture, which may or may not contain additional foaming agents, reinforcement agents, crosslinkers and adjuncts, may be stirred at high speeds using equipment like a cream whipper or an emulsifier to generate stable closed-cell bubbles. The example cellulose mixture of FIG. 1 is shown in FIG. 2 after mechanical mixing. In most aspects, the foam is mixed for a sufficient time (1-100 minutes) such that it retains its shape, even after being tilted 90 (inset below left) or 180 degrees (inset below right) (see FIG. 2).

After thorough mixing, the foaming hydrogel is then poured into molds to achieve a desired shape and lightly vibrated to remove any surface imperfections. FIG. 3 shows a sample mold and molding process. The example foam shown in FIG. 2 is poured into a rectangular mold (FIG. 3, above, shown prior to pouring). The poured foam is then vibrated and levelled with a metal rod (FIG. 3, below).

Usually, for uniform drying times, a thin sheet of uniform thickness (i.e. about 0.5 mm to 10-20 mm) will be poured and molded. For use in various applications, different thicknesses may be achieved through the thicknesses of the pour, or by laminating or layering multiple thin sheets. Overall dimensions (i.e., length and width, curvature, etc.) may be controlled by mold shape or later processing, e.g., stamping, cutting and the like.

Optionally, the foamed cellulose suspension can be sprayed on the surface of desired targets by spray gun, or coating or dipping on the surfaces such as food, fruit, and etc. The drying time relates to the thickness of the cellulose foamed film and environmental humidity and temperature.

### Drying and Curing

The foamed cellulose suspension may be left to dry in ambient conditions or placed in a forced-air oven at temperatures between 0° C. and 80° C. Freeze drying, temperatures from —50° C. to 0° C. may be used in some applications but result in open cell gels. The drying time ranges from 0.1 to 50 hours, depending on the mold thickness. This compares well with freeze-drying, which can take up to 48 hrs, with considerable energy used to freeze the molds and/or generate a vacuum. (see e.g., Jimenze-Saelices et al. Carbohydrate Polymers 2017 1547: 105-113). Often, room temperature or elevated temperatures (in an oven for instance) offers reduced energy usage. Increased airflow may also aid in drying.

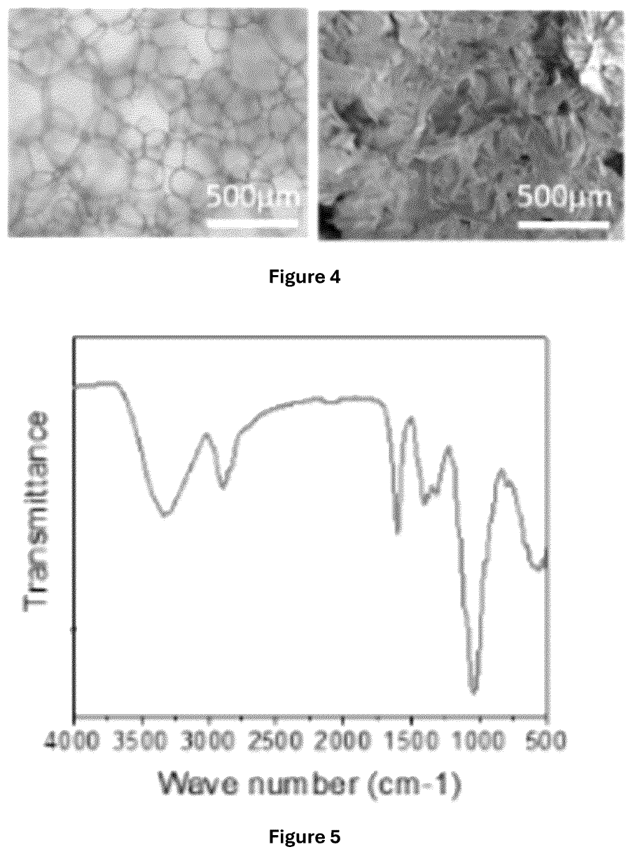

After drying, a closed-cell cellulose aerogel with excellent thermal and acoustic insulation, cushioning properties, and other functionalities, depending on additives is formed. FIG. 4 shows (left) light microscopy and SEM (right) of the highly-aerated foam structure, with the white bars showing 500 μm for reference. The purity of the cellulose-only gel is demonstrated by the FTIR spectrum in FIG. 5, which shows the characteristic transmittance spectrum of cellulose with few if any impurities.

### Optional Waterproofing Treatment

For applications requiring water resistance, the dried cellulose aerogel can be treated with a silane solution or other non-biodegradable, biodegradable, recyclable treatment such as waxes, plastics and the like. In the case of silane, it may be deposited as a thin film on one or both of an aerogel surface through Chemical Vapor Deposition (CVD) process, providing a waterproof coating.

### Recycling

The cellulose aerogel material can be rehydrated and mechanically processed for reuse. After water absorption, the aerogel can be mechanically broken down, for instance using high-speed mixers, followed by repeating the blending, foaming and/or drying processes described above.

### Biodegradability

Most embodiments of the present disclosure are completely biodegradable.

### Example Methods of Preparing a Self-Drying, Closed-Cell Cellulose Aerogel Material

(a) Modify Cellulose to Prepare a Cellulose Mixture Suspension: Cellulose is

modified through an alkylation reaction, adding 10%-50% methoxy groups (—OCH₃) as functional groups, resulting in a viscosity range of 1-10,000 cP. This modified cellulose is then added to 0.5-3% cellulose nanofibrils with 0.1-100 mmol/g of carboxyl (—COOH) groups in a water suspension.
(b) Mixing Process: Combine the alkylated cellulose and cellulose nanofibrils in a ratio between 0.1:1 and 1:0.1. Mix slowly at a speed between 0.1 r/s and 1 r/s for 1-100 minutes to ensure uniform distribution.
(c) High-Speed bubble emulsion: After thorough initial mixing, use a high-speed shear mixer or an emulsion mixer to further process the prepared cellulose suspension for 1-60 minutes, or until the suspension volume increases by 1-3 times to became fluffy, stable foam without flowing under gravity.
(d) Functionalization of emulsion: Optionally, add 0.1-3% silver particle, or copper particle, or other antibacterial agents for antibacterial properties. Optionally, add 0.1-50% elastic rubber particle, carbon nanotube, macro natural fiber, starch, chitosan, and other for mechanical reinforcement. This optional step is usually performed after step (c) and will be used for aerogel functional application.
(e) Drying process: the well-mixed and aerated emulsion is poured into the mold for drying. The drying temperature can be room temperature and range from —50-80° C., however, low humidity and convection could facilitate the drying process and reduce the dehydration time.
(f) Alternate Process: Spray Drying: The cellulose mixture emulsion can be used for spray drying, where it is applied to the surface of the target object to enhance thermal and acoustic insulation properties, along with other functionalities. To minimize drying time, a multi-layer spray approach can be employed. This involves applying the emulsion in thin layers, allowing each internal layer to dry before spraying the next. This method significantly reduces the overall drying time.
(g) Gels and Applications. A self-drying, closed-cell cellulose aerogel material prepared by the method of above, having a density of between 0.001 g/cm³ to 0.2 g/cm³ and exhibiting thermal and acoustic insulation and cushioning resistance properties. This cellulose aerogel can be used in some example applications, including but not limited to: (1) Construction insulation applications; (2) Acoustic insulation applications; (3) Insulation and cushioning packaging applications; (4) Food preservation coating applications; (5) Medical such as wound healing applications; (6) Plastic, aluminum, paper film coating; (7) Seed coatings; (8) EMI shielding materials; (9) Heat storage materials.

### EXAMPLE 1

Use pulp fibers to produce 5 g of methyl cellulose powder and 5 g of TEMPO cellulose nanofibrils at 1% wt water suspension. Then, mix 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel.

### EXAMPLE 2

Use pulp fibers to produce 10 g of methyl cellulose powder and 5 g of TEMPO cellulose nanofibrils at 1% wt water suspension. Then, mix 10 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 7 mm, trimming the edges and corners. Allow it to dry at room temperature (23° C. and 65% humidity) for 25 hours to obtain the 100% cellulose aerogel.

### EXAMPLE 3

Use pulp fibers to produce 5 g of methyl cellulose powder and 5 g of TEMPO cellulose nanofibrils at 1% wt water suspension. Then, mix 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry in an oven (60° C.) for 2 hours to obtain the 100% cellulose aerogel.

### EXAMPLE 4

Use pulp fibers to produce 5 g of methyl cellulose powder and 5 g of TEMPO cellulose nanofibrils at 1% wt water suspension. Then, mix 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 2 mm, trimming the edges and corners. Allow it to dry in an oven (80° C.) for 0.5 hours to obtain the 100% cellulose aerogel.

### EXAMPLE 5

Use pulp fibers to produce 5 g of ethyl cellulose powder and 5 g of TEMPO cellulose nanofibrils at 1% wt water suspension. Then, mix 5 g of ethyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry in an oven (80° C.) for 1 hours to obtain the 100% cellulose aerogel.

### EXAMPLE 6

Use pulp fibers to produce 10 g of ethyl cellulose powder and 5 g of TEMPO cellulose nanofibrils at 0.8% wt water suspension. Then, mix 10 g of ethyl cellulose with 5 g of cellulose nanofibrils using a slow mixer. Afterward, use a high-speed emulsion mixer for 3 minutes until the volume of the hydrogel increases twofold. Pour the foamed emulsion into a mold with a thickness of 5 mm, trimming the edges and corners. Allow it to dry at room temperature (23° C. and 65% humidity) for 25 hours to obtain the 100% cellulose aerogel.

### EXAMPLE 7

Use pulp fibers to produce 2.5 g of ethyl cellulose powder and 5 g of TEMPO cellulose nanofibrils at 1.2% wt water suspension. Then, mix 2.5 g of ethyl cellulose with 5 g of cellulose nanofibrils using a slow mixer. Afterward, use a high-speed emulsion mixer for 3 minutes until the volume of the hydrogel increases up to threefold. Pour the foamed emulsion into a mold with a thickness of 5 mm, trimming the edges and corners. Allow it to dry at oven (80° C.) for 1 hours to obtain the 100% cellulose aerogel.

### EXAMPLE 8

Use pulp fibers to produce 5 g of methyl cellulose powder and 5 g of TEMPO cellulose nanofibrils at 1% wt water suspension. Then, mix 5 g of methyl cellulose with 5 g of cellulose nanofibrils using a slow mixer. Afterward, use a high-speed emulsion mixer for 3 minutes until the volume of the hydrogel increases up to threefold. Spray the emulsion suspension to the surface of object with 0.5 mm thickness by air gun. Allow it to dry at room temperature (23° C. and 65% humidity) for 30 mins, then spray another layer of cellulose emulsion suspension with 0.5 mm thickness and repeat this step until to the design thickness.

### EXAMPLE 9

Use pulp fibers to produce 5 g of methyl cellulose powder and 5 g of TEMPO cellulose nanofibrils at 1% wt water suspension. Then, mix5 g carboxymethyl cellulose, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel has higher mechanical strength than prior examples.

### EXAMPLE 10

Use pulp fibers to produce 5 g of methyl cellulose powder and 5 g of TEMPO cellulose nanofibrils at 1% wt water suspension. Then, mix 5 g starch, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel has better internal bonding capacity.

### EXAMPLE 11

Use pulp fibers to produce 5 g of methyl cellulose powder and 5 g of TEMPO cellulose nanofibrils at 1% wt water suspension. Then, mix 5 g chitosan, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel with positive charge chitosan and negative charge cellulose can be used for an electrostatic dust remover.

### EXAMPLE 12

Use pulp fibers to produce 5 g of methyl cellulose powder and 5 g of TEMPO cellulose nanofibrils at 1% wt water suspension. Then, mix 5 g of methyl cellulose with 5 g of cellulose nanofibrils using a slow mixer. Afterward, use a high-speed emulsion mixer for 3 minutes until the volume of the hydrogel increases up to two to threefold. Dip seeds into the emulsion suspension, ensuring a coating thickness larger than 0.2 mm. Allow them to dry at room temperature (23° C. and 65% humidity) for 30 minutes to achieve seed coating and preservation.

### EXAMPLE 13

Use pulp fibers to produce 5 g of ethyl cellulose powder and 5 g of TEMPO cellulose nanofibrils at 1% wt water suspension. Then, mix 5 g of ethyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at oven (80° C.) for 1 hours to obtain the 100% cellulose aerogel.

### EXAMPLE 14

Use pulp fibers to produce 5 g of methyl cellulose powder and 5 g of TEMPO cellulose nanofibrils at 1% wt water suspension. Then, mix 2 g carbon nanotube, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel is used for EMI shielding materials.

### EXAMPLE 15

Use pulp fibers to produce 5 g of methyl cellulose powder and 5 g of TEMPO cellulose nanofibrils at 1% wt water suspension. Then, mix 0.5 g silver nanoparticles, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel is used for antibacterial materials.

### EXAMPLE 16

Use pulp fibers to produce 5 g of methyl cellulose powder and 5 g of TEMPO cellulose nanofibrils at 1% wt water suspension. Then, mix 0.5g silver nanoparticles, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel is used for antibacterial materials.

### EXAMPLE 17

Use pulp fibers to produce 5 g of methyl cellulose powder and 5 g of TEMPO cellulose nanofibrils at 1% wt water suspension. Then, mix 5 g lignin particles, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23°°C. and 65% humidity) for 20 hours to obtain the 100% cellulose aerogel. This aerogel is used for heat storage materials.

### EXAMPLE 18

Use pulp fibers to produce 5 g of methyl cellulose powder and 5 g of TEMPO cellulose nanofibrils at 1% wt water suspension. Then, mix 5 g lignin particles, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel is used for heat storage materials.

### EXAMPLE 19

Use pulp fibers to produce 5 g of methyl cellulose powder and 5 g of TEMPO cellulose nanofibrils at 1% wt water suspension. Then, mix 5 g elastomer, 5 g of methyl cellulose with 5 g of cellulose nanofibrils using a slow mixer. Afterward, use a high-speed emulsion mixer for 3 minutes until the volume of the hydrogel increases threefold. Pour the foamed emulsion into a mold with a thickness of 5 mm, trimming the edges and corners. Allow it to dry at room temperature (23° C. and 65% humidity) for 20 hours to obtain the 100% cellulose aerogel. This aerogel is used for cushioning resistance.

### EXAMPLE 20

Use pulp fibers to produce 5 g of methyl cellulose powder and 5 g of TEMPO cellulose nanofibrils at 1% wt water suspension. Then, 5 g of methyl cellulose with 5 g of cellulose nanofibrils using a slow mixer. Afterward, use a high-speed emulsion mixer for 3 minutes until the volume of the hydrogel increases two-threefold. Pour the foamed emulsion into a mold with a thickness of 5 mm, trimming the edges and corners. Allow it to dry at room temperature (23° C. and 65% humidity) for 20 hours to obtain the 100% cellulose aerogel. After drying, a small glass vial containing methyltrichlorosilane (5 mL) and the cellulose aerogels were stored in a vacuum desiccator. The desiccator was operated at around 20 kPa and was stored in an oven at 60° C. for 12 h. Thereafter, the surface-treated aerogels were placed in a vacuum desiccator under vacuum for 1 h to remove the unreacted silane and by-product (HCl). This process is used to produce water-proof aerogels.

What is claimed is:

1. A method of preparing a cellulose-based aerogel comprising:
preparing an alkali cellulose;
reacting the alkali cellulose with an alkylating agent to form alkylated cellulose;
mixing the alkylated cellulose with fibrillated cellulose comprising carboxyl groups in an aqueous solution to form a foam;
drying the foam to form a cellulose-based aerogel.

2. The method of claim 1, further comprising pouring the foam into a mold.

3. The method of claim 2, further comprising shaping the foam by vibrating and/or mechanically smoothing the top of the foam.

4. The method of claim 1, further comprising spraying the foam on a surface.

5. The method of claim 1, further comprising contacting a surface with the foam.

6. The method of claim 1, wherein the alkali cellulose is prepared using sodium hydroxide.

7. The method of claim 1, wherein the alkylating agent is selected from one or more of methyl iodide, ethyl iodide, methyl chloride, ethyl chloride (C₂H₅Cl), dimethyl sulfate.

8. The method of claim 1, wherein the fibrillated cellulose is carboxylated via TEMPO-mediated oxidation.

9. The method of claim 1, wherein the fibrillated cellulose is fibrillated using high-pressure homogenization and/or mechanical grinding.

10. The method of claim 1, wherein the alkylated cellulose and fibrillated cellulose are mixed in a ratio of about 0.1:1 to 1:0.1.

11. The method of claim 1, wherein mixing the alkylated cellulose with fibrillated cellulose comprising carboxyl groups in an aqueous solution occurs for a time between about 1 and 100 minutes.

12. The method of claim 1, further comprising adding additional foaming agents, crosslinkers, reinforcement agents, waterproofing agents or other adjuncts to the foam and/or aerogel.

13. The method of claim 1, wherein the aerogel is a closed-cell material.

14. A method of preparing a cellulose-based aerogel, comprising:
rehydrating a first cellulose-based aerogel comprising alkylated cellulose and fibrillated cellulose;
mechanically grinding the rehydrated aerogel;
mixing the ground aerogel in an aqueous solution to form a foam;
drying the foam to form a second cellulose-based aerogel.

15. A cellulose-based closed-foam aerogel, the closed-cell aerogel comprising:
an alkylated cellulose;
a fibrillated carboxylated cellulose;
wherein the alkylated cellulose and the fibrillated carboxylated cellulose are mixed to foam, wherein the foam is capable of being dried under ambient conditions to form the closed-cell aerogel.

16. The cellulose-based closed-foam aerogel of claim 15, wherein alkylated cellulose is prepared from alkali cellulose and an alkylating agent.

17. The cellulose-based closed-foam aerogel of claim 15, wherein the fibrillated carboxylated cellulose is carboxylated via TEMPO-mediated oxidation and fibrillated using high-pressure homogenization and/or mechanical grinding.

18. The cellulose-based closed-foam aerogel of claim 15, wherein the alkylated cellulose and fibrillated cellulose are mixed in a ratio of about 0.1:1 to 1:0.1.

19. The cellulose-based closed-foam aerogel of claim 15, further comprising foaming agents, crosslinkers, reinforcement agents, waterproofing agents and/or other adjuncts.

20. The cellulose-based closed-foam aerogel of claim 15, wherein the aerogel is recyclable and/or biodegradable.
